(19) United States
(12) Patent Application Publication
(10) Pub. No.: US 2025/0046807 A1
(43) Pub. Date: Feb. 6, 2025

(54) A POSITIVE ELECTRODE ACTIVE MATERIAL FOR RECHARGEABLE SOLID-STATE BATTERIES

(71) Applicant: Umicore, Brussels (BE)

(72) Inventors: Shinichi KUMAKURA, Olen (BE); JiHoon KANG, Chungcheongnam-do (KR); GyeongSeo PARK, Chungcheongnam-do (KR)

(21) Appl. No.: 18/718,184

(22) PCT Filed: Dec. 15, 2022
(86) PCT No.: PCT/EP2022/086032

§ 371 Date: Jun. 10, 2024

(30) Foreign Application Priority Data
Dec. 16, 2021 (EP) 21215008.0

(51) Int. Cl. H01M 4/525; C01G 53/00

(52) U.S. Cl. CPC H01M 4/525; C01G 53/44; C01P 2002/50; C01P 2004/61; C01P 2006/40

(57) ABSTRACT

A positive electrode active material can be used for a solid-state rechargeable battery. The positive electrode active material comprises Li, M′, and oxygen. M′ comprises Ni in a content x, Co in a content y, Mn in a content z, an element other than Li, O, Ni, Co, Mn, Al, B, and W in a content a, B in a content b, Al in a content c, and W in a content d, wherein 50.0≤x≤95.0 mol %, 0≤y≤40.0 mol %, 0≤z≤70.0 mol %, 0≤a≤2.0 mol %, 0.01≤b≤1.6 mol %, 0.00≤c≤1.5 mol %, and 0.00≤d≤1.5 mol %, all relative to M′. The positive electrode active material has a B content B_{A} defined as

$$\frac{b}{( x + y + z + b + c + d )} ,$$

and a content B_{B}. B_{B} is expressed as molar fraction compared to the sum of molar fractions of Ni, Mn, Co, B, Al, and W, as measured by XPS analysis, wherein the ratio B_{B}/B_{A}>10.0.

### TECHNICAL FIELD

The present invention relates to a positive electrode active material for a solid-state rechargeable battery. More specifically, the invention relates to the use of a single-crystalline positive electrode active material comprising B element for a solid-state battery, preferably wherein the solid-state battery is a sulfide based solid-state battery.

### BACKGROUND

This invention relates to the use of a single-crystalline positive electrode active material comprising B element for a solid-state rechargeable battery.

The use of positive electrode active materials comprising B in sulfide based solid-state rechargeable batteries is already known, for example from J. Electrochem. Soc., 167, 130516. This article discloses the use of a positive electrode active material powder comprising a poly-crystalline lithium nickel manganese cobalt oxide (NMC) and a lithium boron-based coating, and wherein the NMC had a Ni content of around 80 mol %. The article describes that this material was prepared by dry mixing a H₃BO₃ powder with the NMC followed by heating at 300° C. However, the scientific article discloses that the use of this positive electrode active material in sulfide based solid-state rechargeable batteries results in low discharge capacity (DQ5).

It is therefore an object of the present invention to provide a positive electrode active material having good electrochemical properties, indicated by high discharge capacity (DQ5) for use in a solid-state rechargeable battery, preferably a sulfide based solid-state battery.

### SUMMARY OF THE INVENTION

This objective is achieved by providing the use of a positive electrode active material for a solid-state rechargeable battery, wherein the positive electrode active material comprises Li, M′, and oxygen, wherein M′ comprises:
Ni in a content x, wherein 50≤x≤95.0 mol %, relative to M′,
Co in a content y, wherein 0≤y≤40.0 mol %, relative to M′,
Mn in a content z, wherein 0≤z≤70.0 mol %, relative to M′,
Element other than Li, O, Ni, Co, Mn, Al, B, and W in a content a, wherein 0≤a≤2.0 mol %, relative to M′, and,
B in a content b, wherein 0.01≤b≤1.6 mol %, relative to M′,
Al in a content c, wherein 0.00≤c≤1.5 mol %, relative to M′,
W in a content d, wherein 0.00≤d≤1.5 mol %, relative to M′,
wherein x, y, z, a, b, c, and d are measured by ICP-OES,
wherein x+y+z+a+b+c+d is 100.0 mol %,
wherein the positive electrode active material has a B content B_{A} defined as

$$\frac{b}{( x + y + z + b + c + d )} ,$$

wherein the positive electrode active material has a B content B_{B} wherein B_{B} is determined by XPS analysis, wherein B_{B} is expressed as molar fraction compared to the sum of molar fractions of Ni, Mn, Co, B, Al, and W, as measured by XPS analysis, wherein the ratio B_{B}/B_{A}>10.0, and,
   wherein the material is a single-crystalline powder.

It is indeed observed that by using the positive electrode active material, as described herein above, improved DQ5 is achieved, as illustrated by examples and supported by the results provided in Table 3.

Further, the present invention provides a positive electrode for a solid-state rechargeable battery comprising said positive electrode active material and a solid-state rechargeable battery comprising said positive electrode active material.

The present invention concerns the following embodiments:

### Embodiment 1

In a first embodiment, the present invention provides the use of a positive electrode active material for a solid-state rechargeable battery, wherein the positive electrode active material comprises Li, M′, and oxygen, wherein M′ comprises:
Ni in a content x between 50.0 mol % and 95.0 mol %, relative to M′,
Co in a content y wherein 0≤y≤40.0 mol %, relative to M′,
Mn in a content z wherein 0≤z≤70.0 mol %, relative to M′,
Element other than Li, O, Ni, Co, Mn, Al, and B in a content a, wherein 0≤a≤2.0 mol %, relative to M′, and,
B in a content b, wherein 0.01≤b≤1.6 mol %, relative to M′,
Al in a content c, wherein 0.00≤c≤2.0 mol %, relative to M′,
W in a content d, wherein 0.00≤d≤2.0 mol %, relative to M′,
wherein x, y, z, a, b, c, and d are measured by ICP-OES,
wherein x+y+z+a+b+c+d is 100.0 mol %,
wherein the positive electrode active material has a B content B_{A} defined as

$$\frac{b}{( x + y + z + b + c + d )} ,$$

wherein the positive electrode active material has a B content B_{B} wherein B_{B} is determined by XPS analysis, wherein B_{B} is expressed as molar fraction compared to the sum of molar fractions of Ni, Mn, Co, B, Al, and W, as measured by XPS analysis,
wherein the ratio B_{B}/B_{A}>10.0, and,
   wherein the material is a single-crystalline powder.

### Embodiment 2

In a second embodiment, preferably according to the Embodiment 1, said positive electrode active material comprises Al in a content c, wherein 0.01 mol %≤c≤1.5 mol %, relative to M′, as measured by ICP-OES.

Preferably, the positive electrode active material has an Al content Al_{A} defined as

$$\frac{c}{( x + y + z + b + c + d )} ,$$

wherein the positive electrode active material has an Al content Al_{B} determined by XPS analysis, wherein Al_{B} is expressed as molar fraction compared to the sum of molar fractions of Co, Mn, Ni, Al, B, and W as measured by XPS analysis,
wherein the ratio Al_{B}/Al_{A}>10.0.

Preferably, Al_{B}/Al_{A}>20.0.

More preferably, Al_{B}/Al_{A}>25.0 and most preferably Al_{B}/Al_{A}≥30.0.

Preferably, Al_{B}/Al_{A}<300.0 and more preferably, Al_{B}/Al_{A}≤200.0.

### Embodiment 3

In a third embodiment, preferably according to the Embodiment 1 or 2, said positive electrode active material comprises W in a content d, wherein 0.01 mol %≤d≤2.0 mol %, relative to M′, as measured by ICP-OES.

Preferably, the positive electrode active material has a W content W_{A} defined as

$$\frac{d}{( x + y + z + b + c + d )} ,$$

wherein the positive electrode active material has a W content W_{B} determined by XPS analysis, wherein W_{B} is expressed as molar fraction compared to the sum of molar fractions of Co, Mn, Ni, Al, B, and W, as measured by XPS analysis,
wherein the ratio W_{B}/W_{A}>10.0.

Preferably, W_{B}/W_{A}>20.0.

More preferably, W_{B}/W_{A}>25.0 and most preferably W_{B}/W_{A}≥30.0.

Preferably, W_{B}/W_{A}<300.0 and more preferably, W_{B}/W_{A}≤200.0.

### Embodiment 4

In a fourth embodiment, preferably according to the Embodiments 1 to 3, the present invention provides a catholyte electrode for solid-state rechargeable battery comprising the positive electrode active material as described herein above.

### Embodiment 5

In a fifth embodiment, preferably according to the Embodiments 1 to 4, the present invention provides a positive electrode for solid-state rechargeable battery comprising the positive electrode active material as described herein above.

### Embodiment 6

In a sixth embodiment, preferably according to the Embodiments 1 to 5, the present invention provides a solid-state rechargeable battery comprising the positive electrode active material as described herein above.

### Embodiment 7

In a seventh embodiment, preferably according to the Embodiments 1 to 6, the present invention provides the use of said solid-state rechargeable battery of either one of a portable computer, a tablet, a mobile phone, an electrically powered vehicle, and an energy storage system.

### BRIEF DESCRIPTION OF THE FIGURES

FIG. 1. Comparison of DQ5 (in mAh/g, y-axis) according to the amount of B in the positive electrode active material (in mol %, x-axis) for EX2.1, EX2.2, EX2.3, EX2.4, CEX2.1, CEX2.2, and CEX3

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention. As used herein, the following terms have the following meanings:

The term “ppm” as used in this document means parts per million on a mass basis.

The term “median particle size D50”, as defined herein, can be interchangeably used with the terms “D50” or “d50” or “median particle size” or “a median particle size (d50 or D50)”. D50 is defined herein as the particle size at 50% of the cumulative volume % distributions. D50 is typically determined by laser diffraction particle size analysis.

A positive electrode active material is defined as a material which is electrochemically active in a positive electrode. By active material, it must be understood a material capable to capture and release Li ions when subjected to a voltage change over a predetermined period of time.

In the following detailed description, preferred embodiments are described to enable the practice of the invention. Although the invention is described with reference to these specific preferred embodiments, it will be understood that the following examples are intended to further clarify the present invention and are nowhere intended to limit the scope of the present invention. The invention includes numerous alternatives, modifications and equivalents that are apparent from consideration of the following detailed description and accompanying drawings.

### Positive Electrode Active Material and Use Thereof

In a first aspect, the present invention provides the use of a positive electrode active material for a solid-state rechargeable battery.

Typically, said positive electrode active material is a positive electrode active material suitable for use for a solid-state rechargeable battery, wherein the positive electrode active material comprises Li, M′, and oxygen, wherein M′ comprises:
Ni in a content x between 50.0 mol % and 95.0 mol %, relative to M′,
Co in a content y wherein 0≤y≤40.0 mol %, relative to M′,
Mn in a content z wherein 0≤z≤70.0 mol %, relative to M′, preferably Mn in a content z wherein 0≤z≤40.0 mol %,
Element other than Li, O, Ni, Co, Mn, Al, and B in a content a, wherein 0≤a≤2.0 mol %, relative to M′, and,
B in a content b, wherein 0.01≤b≤1.6 mol %, relative to M′,
Al in a content c, wherein 0.00≤c≤2.0 mol %, relative to M′,
W in a content d, wherein 0.00≤d≤2.0 mol %, relative to M′,
wherein x, y, z, a, b, c, and d are measured by ICP-OES,
wherein x+y+z+a+b+c+d is 100.0 mol %,
wherein the positive electrode active material has a B content B_{A} defined as

$$\frac{b}{( x + y + z + b + c + d )} ,$$

wherein the positive electrode active material has a B content B_{B} wherein B_{B} is determined by XPS analysis, wherein B_{B} is expressed as molar fraction compared to the sum of molar fractions of Ni, Mn, Co, B, Al, and W, as measured by XPS analysis,
wherein the ratio B_{B}/B_{A}>10.0, and,
   wherein the material is a single-crystalline powder.

The concept of single-crystalline powders is well known in the technical field of positive electrode active material. It concerns powders having mostly single-crystalline particles.

Such powder is a separate class of powders compared to poly-crystalline powders, which are made of particles which are mostly poly-crystalline. The skilled person can easily distinguish such these two classes of powders based on a microscopic image.

Single-crystal particles are also known in the technical field as monolithic particles, one-body particles or and mono-crystalline particles.

Even though a technical definition of a single-crystalline powder is superfluous, as the skilled person can easily recognize such a powder with the help of an SEM, in the context of the present invention, single-crystalline powders may be considered to be defined as powders in which 80% or more of the number of particles are single-crystalline particles. This may be determined on an SEM image having a field of view of at least 45 μm×at least 60 μm (i.e. of at least 2700 μm²), and preferably of: at least 100 μm×100 μm (i.e. of at least 10,000 μm²).

Single-crystalline particles are particles which are individual crystals, or which are formed of a less than five, and preferably at most three, primary particles which are themselves individual crystals. This can be observed in proper microscope techniques like Scanning Electron Microscope (SEM) by observing grain boundaries.

For the determination whether particles are single-crystalline particles, grains which have a largest linear dimension, as observed by SEM, which is smaller than 20% of the median particle size D50 of the powder, as determined by laser diffraction, are ignored. This avoids that particles which are in essence single-crystalline, but which may have deposited on them several very small other grains, for instance a poly-crystalline coating, are inadvertently considered as not being a single-crystalline particle.

The XPS analysis provides atomic content of elements in an uppermost layer of a particle with a penetration depth of about 10 nm from an outer boundary of the particle. The outer boundary of the particle is also referred to as “surface”.

The composition of the positive electrode active material particle can be expressed as the indices a, x, y, z, a, and d in a general formula Li_{1+b}(NiₐMn_{y}CoₓA_{c}D_{z})_{1-b}O₂, according to the stoichiometry of the elements determined by known analysis methods, such as ICP-OES (Inductively coupled plasma—optical emission spectrometry, also referred hereafter as ICP) and IC (ion chromatography). ICP analysis provides the weight fraction of elements in a positive electrode active material particle.

In the framework of the present invention, at % signifies atomic percentage. The at % or “atomic percent” of a given element expression of a concentration means how many percent of all atoms in the concerned compound are atoms of said element. Further in the framework of the present invention the designation at % is equivalent to mol % or “molar percent”.

Preferably, the positive electrode active material has a nickel content x, relative to M′, of at least 50.0 mol %, at least 55.0 mol %, or even at least 60.0 mol %, as measured by ICP-OES.

Preferably, the positive electrode active material has a nickel content x, relative to M′, of at most 95.0 mol %, at most 92.0 mol %, or even at most 91.0 mol %, as measured by ICP-OES.

Preferably, the positive electrode active material has a nickel content x, relative to M′, of 50.0≤x≤70.0, preferably 55.0≤x≤70.0, more preferably 58.0≤x≤68.0.

Preferably, the positive electrode active material has a nickel content x, relative to M′, of 70.0<x≤95.0, preferably 75.0≤x≤90.0, more preferably 78.0≤x≤88.0.

Preferably, the positive electrode active material has a cobalt content y, relative to M′, of at least 0.0 mol %, at least 1.0 mol %, or even at least 3.0 mol %, as measured by ICP-OES.

Preferably, the positive electrode active material has a cobalt content y, relative to M′, of at most 40.0 mol %, at most 30.0 mol %, or even at most 20.0 mol %, as measured by ICP-OES.

In certain preferred embodiments, the positive electrode active material has a cobalt content y, relative to M′, of at most 20.0 mol %, at most 15.0 mol %, or even at most 15.0 mol %, as measured by ICP-OES.

In certain preferred embodiments, the positive electrode active material has a cobalt content y, relative to M′, wherein 0.0 mol %≤y≤20.0 mol %, preferably 1.0 mol %≤y≤15.0 mol %, more preferably 3.0 mol %≤y≤10.0 mol % as measured by ICP-OES.

Preferably, the positive electrode active material has a manganese content z, relative to M′, of at least 0.0 mol %, at least 3.0 mol %, or even at least 5.0 mol %, as measured by ICP-OES.

Preferably, the positive electrode active material has a manganese content z, relative to M′, of at most 70.0 mol %, at most 50.0 mol %, or even at most 30.0 mol %, as measured by ICP-OES.

In certain preferred embodiments, the positive electrode active material has a manganese content z, relative to M′, of at most 20.0 mol %, at most 15.0 mol %, or even at most 10.0 mol %, as measured by ICP-OES.

In certain preferred embodiments, the positive electrode active material has a manganese content z, relative to M′, wherein 0.0 mol %≤z≤20.0 mol %, preferably 1.0 mol %≤z≤15.0 mol %, more preferably 3.0 mol %≤z≤10.0 mol % as measured by ICP-OES.

Preferably, the positive electrode active material has boron content b, relative to M′, of at least 0.01 mol %, more preferably at least 0.05 mol %, or even more preferably at least 0.1 mol %, as measured by ICP-OES.

Preferably, the positive electrode active material has a boron content b, relative to M′, of at most 1.6 mol %, more preferably at most 1.5 mol %, even more preferably at most 1.4 mol %, most preferably at most 1.3 mol %, or in particular preferably at most 1.2 mol %.

Preferably, the positive electrode active material wherein a molar ratio of lithium to the total molar amount of nickel, manganese, and/or cobalt is 0.95≤Li:Me≤1.10 wherein Me is a total molar fraction of Ni, Mn, and/or Co.

Preferably, the positive electrode active material has B_{B}/B_{A}>30.0, more preferably B_{B}/B_{A}>35.0, even more preferably B_{B}/B_{A}≥40.0 and most preferably B_{B}/B_{A}>60.0.

Preferably, B_{B}/B_{A}<300.0 and more preferably, B_{B}/B_{A}≤200.0.

Preferably, said positive electrode active material comprises Al in a content c, wherein 0.01 mol %≤c≤1.5 mol %, relative to M′, as measured by ICP-OES.

Preferably, the positive electrode active material has an Al content Al_{A} defined as

$$\frac{c}{( x + y + z + b + c + d )} ,$$

wherein the positive electrode active material has an Al content Al_{B} determined by XPS analysis, wherein Al_{B} is expressed as molar fraction compared to the sum of molar fractions of Co, Mn, Ni, Al, B, and W, as measured by XPS analysis,
wherein the ratio Al_{B}/Al_{A}>10.0.

Preferably, Al_{B}/Al_{A}>20.0.

More preferably, Al_{B}/Al_{A}>25.0 and most preferably Al_{B}/Al_{A}≥30.0.

Preferably, Al_{B}/Al_{A}<300.0 and more preferably, Al_{B}/Al_{A}≤200.0.

Preferably, said positive electrode active material comprises W in a content d, wherein 0.01 mol %≤d≤2.0 mol %, relative to M′, as measured by ICP-OES.

Preferably, the positive electrode active material has a W content W_{A} defined as

$$\frac{d}{( x + y + z + b + c + d )} ,$$

wherein the positive electrode active material has a W content W_{B} determined by XPS analysis, wherein W_{B} is expressed as molar fraction compared to the sum of molar fractions of Co, Mn, Ni, Al, B, and W, as measured by XPS analysis,
wherein the ratio W_{B}/W_{A}>10.0.

Preferably, W_{B}/W_{A}>20.0.

More preferably, W_{B}/W_{A}>25.0 and most preferably W_{B}/W_{A}≥30.0.

Preferably, W_{B}/W_{A}<300.0 and more preferably, W_{B}/W_{A}≤200.0.

In a preferred embodiment, the Element other than Li, O, Ni, Co, Mn, Al, and B is one or more elements selected from the group consisting of Ba, Ca, Cr, Fe, Mg, Mo, Nb, S, Si, Sr, Ti, Y, V, Zn, and Zr, preferably Cr, Nb, S, Si, Y and Zr; more preferably Nb and Zr.

A certain preferred embodiment is the positive electrode active material according to the invention, wherein the Element other than Li, O, Ni, Co, Mn, Al, and B is in a content a>0.0 mol %, preferably a≥0.25 mol %, more preferably a≥0.5 mol %. In a preferred embodiment the content a<2.0 mol %, preferably a≤1.75 mol %, more preferably a≤1.5 mol %. In a preferred embodiment the content is 0.0 mol %<a<2.0 mol %, preferably 0.25 mol %≤a≤1.75 mol %, more preferably 0.5 mol %≤a≤1.5 mol %.

In a certain preferred embodiment the positive electrode active material comprises Li, M′, and oxygen, wherein M′ comprises:
Ni in a content x between 50.0 mol % and 95.0 mol %, relative to M′,
Co in a content y wherein 0≤y≤40.0 mol %, relative to M′,
Mn in a content z wherein 0≤z≤70.0 mol %, relative to M′, preferably Mn in a content z wherein 0≤z≤40.0 mol %,
Element other than Li, O, Ni, Co, Mn, Al, W and B in a content a, wherein 0≤a≤2.0 mol %, relative to M′, and,
B in a content b, wherein 0.01≤b≤1.6 mol %, relative to M′,
Al in a content c, wherein 0.00≤c≤2.0 mol %, relative to M′,
W in a content d, wherein 0.00≤d≤2.0 mol %, relative to M′,
wherein x, y, z, a, b, c, and d are measured by ICP-OES,
wherein x+y+z+a+b+c+d is 100.0 mol %,
wherein the positive electrode active material has a B content B_{A} defined as

$$\frac{b}{( x + y + z + b + c + d )} ,$$

wherein the positive electrode active material has a B content B_{B} wherein B_{B} is determined by XPS analysis, wherein B_{B} is expressed as molar fraction compared to the sum of molar fractions of Ni, Mn, Co, B, Al, and W, as measured by XPS analysis,
wherein the ratio B_{B}/B_{A}>10.0, and,
   wherein the material is a single-crystalline powder.

In a certain preferred embodiment, the Element other than Li, O, Ni, Co, Mn, Al, W and B is one or more elements selected from the group consisting of Ba, Ca, Cr, Fe, Mg, Mo, Nb, S, Si, Sr, Ti, Y, V, Zn, and Zr, preferably Cr, Nb, S, Si, Y and Zr; more preferably Nb and Zr.

A certain preferred embodiment is the positive electrode active material according to the invention, wherein the Element other than Li, O, Ni, Co, Mn, Al, W and B is in a content a>0.0 mol %, preferably a≥0.25 mol %, more preferably a≥0.5 mol %. In a preferred embodiment the content a<2.0 mol %, preferably a≤1.75 mol %, more preferably a≤1.5 mol %. In a preferred embodiment the content is 0.0 mol %<a<2.0 mol %, preferably 0.25 mol %≤a≤1.75 mol %, more preferably 0.5 mol %≤a≤1.5 mol %.

As appreciated by the skilled person the defined ratio of Al_{B}/Al_{A}, B_{B}/B_{A} and W_{B}/W_{A} refers to the positive electrode active material having an enriched amount of Al, B and/or W in the surface layer of the positive electrode active material. Worded differently, the positive electrode active material of the invention comprises a coating layer of Al, B and/or W.

In the context of the present invention the positive electrode active material may comprise a further coating layer comprising the Element other than Li, O, Ni, Co, Mn, Al, W and B, wherein the Element other than Li, O, Ni, Co, Mn, Al, W and B is at least one element selected from the group consisting of Ba, Ca, Cr, Fe, Mg, Mo, Nb, S, Si, Sr, Ti, Y, V, Zn, and Zr, preferably Cr, Nb, S, Si, Y and Zr; more preferably Nb and Zr, wherein the coating layer of Al, B and/or W may be placed on the further coating layer and/or the further coating layer may be placed on the coating layer of Al, B and/or W and/or the positive electrode active layer may comprise a mixed coating layer comprising the coating layer of Al, B and/or W and the further coating layer.

Preferably, said positive electrode active material typically has a median particle size (d50 or D50) of 2.0 μm to 10.0 μm, as determined by laser diffraction. The median particle size (d50 or D50) can be measured with a Malvern Mastersizer 3000. Preferably, said median particle size is between 2.0 μm and 9.0 μm, and more preferably between 3.0 μm and 8.0 μm.

Preferably, the solid-state rechargeable battery is a sulfide based solid-state battery.

### Catholyte

In a second aspect, the present invention provides a catholyte or a composite positive electrode active material for a solid-state rechargeable battery comprising a positive electrode active material and a solid electrolyte, and wherein the positive electrode active material is according to that described in the first aspect of the invention.

In the context of the present invention a catholyte or a composite positive active material are interchangeable terms and both refer to a composite comprising a positive electrode active material and a solid electrolyte.

Preferably, the solid electrolyte is a sulfur based electrolyte. Suitable sulfur based electrolyte may include any used in the lithium battery field. Any sulfur based electrolyte available on the market, or a suitable sulfur based electrolyte may be manufactured by crystallizing an amorphous sulfide containing compound, may suitably be used. Typically, the following sulfur containing compounds of Li₆PS₅Cl (LPSCL), Thio-LISICON (Li_{3.25}Ge_{0.25}P_{0.75}S₄), Li₂S—P₂S₅—LiCl, LiC₂S—SiS₂, LiI—Li₂S—SiS₂, Li—P₂S₅—LiCl, LiC₂S—SiS₂, LiI—Li₂S—SiS₂, LiI—Li₂S—P₂S₅, LiI—Li₂SP₂O₅, LiI—Li₃PO₄—P₂S₅, Li₂S—P₂S₅, Li₃PS₄, Li₇P₃S₁₁, LiI—Li₂S—B₂S₃, Li₃PO₄—Li₂S—Si₂S, Li₃PO₄Li₂S—SiS₂, LiPO₄—Li₂S—SiS, Li₁₀GeP₂S₁₂, Li_{9.54}Si_{1.74}P_{1.44}S_{11.7}Cl_{0.3}, and/or Li₇P₃S₁₁ may be suitably used. Alternatively, the following sulfur containing compounds of Li₆PS₅X with X being F, Br, Cl or I, preferably Br or Cl; thio-LISICON (Li_{3.25}Ge_{0.25}P_{0.75}S₄), Li₂S—P₂S₅—LiCl, Li₂S—SiS₂, LiI—Li₂S—SiS₂, Li₂S—P₂S₅—LiCl, Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄, Li₇P₃S₁₁, LiI—Li₂S—B₂S₃, Li₃PO₄—Li₂S—SiS₂, Li₃PO₄—Li₂S—SiS₂, Li₃PO₄—Li₂S—SiS₂, Li₁₀GeP₂S₁₂, Li_{9.54}Si_{1.74}P_{1.44}S_{11.7}Cl_{0.3}, and/or Li₇P₃S₁₁ may be suitably used.

Preferably, the solid-state rechargeable battery is a sulfide based solid-state battery.

### Positive Electrode

In a third aspect, the present invention provides a positive electrode for a solid-state rechargeable battery comprising a positive electrode active material according to that described in the first aspect of the invention.

Preferably, the solid-state rechargeable battery is a sulfide based solid-state battery.

### Electrochemical Cell

In a fourth aspect, the present invention provides a solid-state rechargeable battery comprising a positive electrode active material according to that described in the first aspect of the invention.

Preferably, the solid-state rechargeable battery is a sulfide based solid-state battery.

In a preferred embodiment the solid-state battery comprises a sulfide-based electrolyte. Preferably said electrolyte is a sulfide-based solid electrolyte, more preferably the electrolyte comprises Li, P, and S. Typically, the following sulfur containing compounds of Li₆PS₅X with X being F, Br, Cl or I, preferably Br or Cl; thio-LISICON (Li_{3.25}Ge_{0.25}P_{0.75}S₄), Li₂S—P₂S₅—LiCl, Li₂S—SiS₂, LiI—Li₂S—SiS₂, Li₂S—P₂S₅—LiCl, Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄, Li₇P₃S₁₁, LiI—Li₂S—B₂S₃, Li₃PO₄—Li₂S—SiS₂, Li₃PO₄—Li₂S—SiS₂, Li₃PO₄—Li₂S—SiS₂, Li₁₀GeP₂S₁₂, Li_{9.54}Si_{1.74}P_{1.44}S_{11.7}Cl_{0.3}, and/or Li₇P₃S₁₁ may be suitably used. In a highly preferred embodiment the battery is a sulfide solid-state battery.

Preferably, the solid-state battery further comprises an anode comprising anode active material. Suitable electrochemically active anode materials are those known in the art. For example, the anode may comprise graphitic carbon, metallic lithium or a metal alloy comprising lithium, such as Li—In alloy, as the anode active material.

In a fifth aspect, the present invention provides a use of a battery according to the fourth aspect of the invention of either one of a portable computer, a tablet, a mobile phone, an electrically powered vehicle, and an energy storage system.

### 1. Description of Analysis Method

### 1.1. Inductively Coupled Plasma

The composition of a positive electrode active material powder is measured by the inductively coupled plasma (ICP) method using an Agilent 720 ICP-OES. 1 gram of powder sample is dissolved into 50 mL of high purity hydrochloric acid (at least 37 wt. % of HCl with respect to the total weight of solution) in an Erlenmeyer flask. The flask is covered by a watch glass and heated on a hot plate at 380° C. until the powder is completely dissolved. After being cooled to room temperature, the solution from the Erlenmeyer flask is poured into a first 250 mL volumetric flask. Afterwards, the first volumetric flask is filled with deionized water up to the 250 mL mark, followed by a complete homogenization process (1^{st} dilution). An appropriate amount of the solution from the first volumetric flask is taken out by a pipette and transferred into a second 250 mL volumetric flask for the 2^{nd} dilution, where the second volumetric flask is filled with an internal standard element and 10% hydrochloric acid up to the 250 mL mark and then homogenized. Finally, this solution is used for ICP measurement.

### 1.2. Particle Size Distribution

The particle size distribution (PSD) of the positive electrode active material powder is measured by laser diffraction particle size analysis using a Malvern Mastersizer 3000 with a Hydro MV wet dispersion accessory after having dispersed each of the powder samples in an aqueous medium. In order to improve the dispersion of the powder, sufficient ultrasonic irradiation and stirring are applied, and an appropriate surfactant is introduced. D50 is defined as the particle size at 50% of the cumulative volume % distributions obtained from the Malvern Mastersizer 3000 with Hydro MV measurements.

### 1.3. Sulfide Solid-State Rechargeable Battery Test

### 1.3.1. Sulfide Solid-State Rechargeable Battery Preparation

### Positive Electrode Preparation:

For the preparation of a positive electrode, a slurry contains positive electrode active material powder, Li—P—S based solid electrolyte, carbon (Super-P, Timcal), and binder (RC-10, Arkema)—with a formulation of 64.0:30.0:3.0:3.0 by weight—in butyl acetate solvent is mixed in Ar-filled glove box. The slurry is casted on one side of an aluminum foil followed by drying the slurry coated foil in a vacuum oven to obtain a positive electrode. The obtained positive electrode is punched with a diameter of 10 nm wherein the active material loading amount is around 4 mg/cm².

### Negative Electrode Preparation:

For the preparation of negative electrode, Li foil (diameter 3 mm, thickness 100 μm) is placed centered on the top of In foil (diameter 10 nm, thickness 100 μm) and pressed to form Li—In alloy negative electrode.

### Separator

For the preparation of separator which also has a function of the solid electrolyte in a battery, the Li—P—S based solid electrolyte is pelletized with a pressure of 250 MPa to obtain 100 μm pellet thickness.

### Cell Assembly

A sulfide solid-state rechargeable battery is assembled in an argon-filled glovebox with such order from bottom to top: positive electrode comprising Al current collector with the coated part on the top—separator—negative electrode with Li side on the top—Cu current collector. The stacked components are pressed together with a pressure of 250 MPa and placed in an external cage to prevent air exposure.

### 1.3.2. Testing Method

The testing method is a conventional “constant cut-off voltage” test. The conventional cell test in the present invention follows the schedule shown in Table 1. Each cell is cycled at 60° C. using a Toscat-3100 computer-controlled galvanostatic cycling station (from Toyo).

The schedule uses a 1C current definition of 160 mA/g. The initial charge capacity (CQ1) and discharge capacity (DQ1) are measured in constant current mode (CC) at C rate of 0.1 C in voltage range 4.3 V to 2.5 V (Li/Li⁺) or 3.7 V to 1.9 V (InLi/Li⁺). DQ5 is the discharge capacity at the 5^{th} cycle.

TABLE 1
Cycling schedule for sulfide solid-state rechargeable battery testing method

| | Charge | | | | Discharge | | | |
|---|---|---|---|---|---|---|---|---|
| Cycle | | End | Rest | V/Li metal | | End | Rest | V/Li metal |
| (#) | C Rate | current | (min) | (V) | C Rate | current | (min) | (V) |
| 1 | 0.1 | — | 10 | 4.3 | 0.1 | — | 10 | 2.5 |
| 2 | 0.2 | 0.05 | 10 | 4.3 | 0.2 | — | 10 | 2.5 |
| 3 | 0.2 | 0.05 | 10 | 4.3 | 0.33 | — | 10 | 2.5 |
| 4 | 0.2 | 0.05 | 10 | 4.3 | 0.5 | — | 10 | 2.5 |
| 5 | 0.2 | 0.05 | 10 | 4.3 | 1 | — | 10 | 2.5 |

### 1.4. X-Ray Photoelectron Spectroscopy (XPS)

In the present invention, X-ray photoelectron spectroscopy (XPS) is used to analyze the surface of positive electrode active material powder particles. In XPS measurement, the signal is acquired from the first few nanometers (e.g., 1 nm to 10 nm) of the uppermost part of a sample, i.e., surface layer. Therefore, all elements measured by XPS are contained in the surface layer.

For the surface analysis of positive electrode active material powder particles, XPS measurement is carried out using a Thermo K-α+ spectrometer. Monochromatic Al Kα radiation (hu=1486.6 eV) is used with a spot size of 400 μm and measurement angle of 45°. A wide survey scan to identify elements present at the surface is conducted at 200 eV pass energy. C1s peak having a maximum intensity (or centered) at a binding energy of 284.8 eV is used as a calibrate peak position after data collection. Accurate narrow scans are performed afterwards at 50 eV for at least 10 scans for each identified element to determine the precise surface composition.

Curve fitting is done with CasaXPS Version2.3.19PR1.0 using a Shirley-type background treatment and Scofield sensitivity factors. The fitting parameters are according to Table 2a. Line shape GL(30) is the Gaussian/Lorentzian product formula with 70% Gaussian line and 30% Lorentzian line. LA(α, β, m) is an asymmetric line-shape where α and β define tail spreading of the peak and m define the width.

TABLE 2a
XPS fitting parameter for Ni2p3,
Mn2p3, Co2p3, Al2p, B1s, and W4f.

| | | Fitting | | |
|---|---|---|---|---|
| | Sensitivity | range | Defined | |
| Element | factor | (eV) | peak(s) | Line shape |
| Ni | 14.61 | 851.1 ± 0.1- | Ni2p3, Ni2p3 | LA(1.33, |
| | | 869.4 ± 0.1 | satellite | 2.44, 69) |
| Mn | 9.17 | 639.9 ± 0.1- | Mn2p3, Mn2p3 | GL(30) |
| | | 649.5 ± 0.1 | satellite | |
| Co | 12.62 | 775.4 ± 0.1- | Co2p3-1, Co2p3-2, | GL(30) |
| | | 792.7 ± 0.3 | Co2p3 satellite | |
| Al | 0.54 | 78.5 ± 0.1- | Al2p peak, Ni3p1, | GL(30) |
| | | 64.1 ± 0.1 | Ni3p3, Ni3p1 | |
| | | | satellite, Ni3p3 | |
| | | | satellite | |
| B | 0.49 | 187.0 ± 0.1- | B1s peak | GL(30) |
| | | 196.3 ± 0.1 | | |
| W | 9.8 | 32.0 ± 0.1- | W4f7, W4f5, | GL(30) |
| | | 43.0 ± 0.1 | and W5p3 | |

For Al, Co, and W peaks, constraints are set for each defined peak according to Table 2b. Ni3p and W5p3 are not quantified.

TABLE 2b
XPS fitting constraints for Al2p peak fitting.

| | | Fitting range | FWHM | |
|---|---|---|---|---|
| Element | Defined peak | (eV) | (eV) | Area |
| Al | Ni3p3 | 66.0-68.0 | 0.5-2.9 | No constraint set |
| | Ni3p1 | 68.0-70 | Equal to | 50% of Ni3p3 area |
| | | | Ni3p3 | |
| | Ni3p3 satellite | 71.0-72.0 | 0.5-2.9 | 40% of Ni3p3 area |
| | Ni3p1 satellite | 73.0-75.0 | 0.5-2.9 | 20% of Ni3p3 area |
| | Al2p peak | 74.0-76.0 | 0.5-3.0 | No constraint set |
| Co | Co2p3-1 | 776.0-780.9 | 0.5-4.0 | No constraint set |
| | Co2p3-2 | 781.0-785.0 | 0.5-4.0 | No constraint set |
| | Co2p3 satellite | 785.1-792.0 | 0.5-4.0 | No constraint set |
| W | W4f7 | 33.0-36.0 | 0.2-4.0 | No constraint set |
| | W4f5 | 36.1-39.0 | Equal to | 75% of W4f7 area |
| | | | W4f7 | |
| | W5p3 | 39.1-43.0 | 0.5-2.5 | No constraint set |

The Al, B, and W surface contents as determined by XPS are expressed as molar fractions of Al, B, and W, respectively, in the surface layer of the particles divided by the total content of Ni, Mn, Co, Al, B, and W, in said surface layer. It is calculated as follows:

$${Al}_{B} = Al ( at \% ) / ( Ni ( at \% ) + Mn ( at \% ) + Co ( at \% ) + B ( at \% ) + Al ( at \% ) + W ( at \% ) ) * 100 \\ {B}_{B} = B ( at \% ) / ( Ni ( at \% ) + Mn ( at \% ) + Co ( at \% ) + B ( at \% ) + Al ( at \% ) + W ( at \% ) ) * 100 \\ {W}_{B} = W ( at \% ) / ( Ni ( at \% ) + Mn ( at \% ) + Co ( at \% ) + B ( at \% ) + Al ( at \% ) + W ( at \% ) ) * 100.$$

### EXAMPLES

### 1. Description of Analysis Method

### 1.1. Inductively Coupled Plasma

The composition of a positive electrode active material powder is measured by the inductively coupled plasma (ICP) method using an Agilent 720 ICP-OES. 1 gram of powder sample is dissolved into 50 mL of high purity hydrochloric acid (at least 37 wt. %/of HCl with respect to the total weight of solution) in an Erlenmeyer flask. The flask is covered by a watch glass and heated on a hot plate at 380° C. until the powder is completely dissolved. After being cooled to room temperature, the solution from the Erlenmeyer flask is poured into a first 250 mL volumetric flask. Afterwards, the first volumetric flask is filled with deionized water up to the 250 mL mark, followed by a complete homogenization process (1^{st} dilution). An appropriate amount of the solution from the first volumetric flask is taken out by a pipette and transferred into a second 250 mL volumetric flask for the 2^{nd} dilution, where the second volumetric flask is filled with an internal standard element and 10% hydrochloric acid up to the 250 mL mark and then homogenized. Finally, this solution is used for ICP measurement.

### 1.2. Particle Size Distribution

The particle size distribution (PSD) of the positive electrode active material powder is measured by laser diffraction particle size analysis using a Malvern Mastersizer 3000 with a Hydro MV wet dispersion accessory after having dispersed each of the powder samples in an aqueous medium. In order to improve the dispersion of the powder, sufficient ultrasonic irradiation and stirring are applied, and an appropriate surfactant is introduced. D50 is defined as the particle size at 50% of the cumulative volume % distributions obtained from the Malvern Mastersizer 3000 with Hydro MV measurements.

### 1.3. Sulfide Solid-State Rechargeable Battery Test

### 1.3.1. Sulfide Solid-State Rechargeable Battery Preparation

### Positive Electrode Preparation:

For the preparation of a positive electrode, a slurry contains positive electrode active material powder, Li—P—S based solid electrolyte, carbon (Super-P, Timcal), and binder (RC-10, Arkema)—with a formulation of 64.0:30.0:3.0:3.0 by weight—in butyl acetate solvent is mixed in Ar-filled glove box. The slurry is casted on one side of an aluminum foil followed by drying the slurry coated foil in a vacuum oven to obtain a positive electrode. The obtained positive electrode is punched with a diameter of 10 nm wherein the active material loading amount is around 4 mg/cm².

### Negative Electrode Preparation:

For the preparation of negative electrode, Li foil (diameter 3 mm, thickness 100 μm) is placed centered on the top of In foil (diameter 10 nm, thickness 100 μm) and pressed to form Li—In alloy negative electrode.

### Separator

For the preparation of separator which also has a function of the solid electrolyte in a battery, the Li—P—S based solid electrolyte is pelletized with a pressure of 250 MPa to obtain 100 μm pellet thickness.

### Cell Assembly

A sulfide solid-state rechargeable battery is assembled in an argon-filled glovebox with such order from bottom to top: positive electrode comprising Al current collector with the coated part on the top—separator—negative electrode with Li side on the top—Cu current collector. The stacked components are pressed together with a pressure of 250 MPa and placed in an external cage to prevent air exposure.

### 1.3.2. Testing Method

The testing method is a conventional “constant cut-off voltage” test. The conventional cell test in the present invention follows the schedule shown in Table 1. Each cell is cycled at 60° C. using a Toscat-3100 computer-controlled galvanostatic cycling station (from Toyo). The schedule uses a 1C current definition of 160 mA/g. The initial charge capacity (CQ1) and discharge capacity (DQ1) are measured in constant current mode (CC) at C rate of 0.1 C in voltage range 4.3 V to 2.5 V (Li/Li⁺) or 3.7 V to 1.9 V (InLi/Li⁺). DQ5 is the discharge capacity at the 5^{th} cycle.

TABLE 1
Cycling schedule for sulfide solid-state rechargeable battery testing method

| | Charge | | | | Discharge | | | |
|---|---|---|---|---|---|---|---|---|
| Cycle | | End | Rest | V/Li metal | | End | Rest | V/Li metal |
| (#) | C Rate | current | (min) | (V) | C Rate | current | (min) | (V) |
| 1 | 0.1 | — | 10 | 4.3 | 0.1 | — | 10 | 2.5 |
| 2 | 0.2 | 0.05 | 10 | 4.3 | 0.2 | — | 10 | 2.5 |
| 3 | 0.2 | 0.05 | 10 | 4.3 | 0.33 | — | 10 | 2.5 |
| 4 | 0.2 | 0.05 | 10 | 4.3 | 0.5 | — | 10 | 2.5 |
| 5 | 0.2 | 0.05 | 10 | 4.3 | 1 | — | 10 | 2.5 |

### 1.4. X-Ray Photoelectron Spectroscopy (XPS)

In the present invention, X-ray photoelectron spectroscopy (XPS) is used to analyze the surface of positive electrode active material powder particles. In XPS measurement, the signal is acquired from the first few nanometers (e.g., 1 nm to 10 nm) of the uppermost part of a sample, i.e., surface layer. Therefore, all elements measured by XPS are contained in the surface layer.

For the surface analysis of positive electrode active material powder particles, XPS measurement is carried out using a Thermo K-α+ spectrometer. Monochromatic Al Kα radiation (hu=1486.6 eV) is used with a spot size of 400 μm and measurement angle of 45°. A wide survey scan to identify elements present at the surface is conducted at 200 eV pass energy. C1s peak having a maximum intensity (or centered) at a binding energy of 284.8 eV is used as a calibrate peak position after data collection. Accurate narrow scans are performed afterwards at 50 eV for at least 10 scans for each identified element to determine the precise surface composition.

Curve fitting is done with CasaXPS Version2.3.19PR1.0 using a Shirley-type background treatment and Scofield sensitivity factors. The fitting parameters are according to Table 2a. Line shape GL(30) is the Gaussian/Lorentzian product formula with 70% Gaussian line and 30% Lorentzian line. LA(α, β, m) is an asymmetric line-shape where α and β define tail spreading of the peak and m define the width.

TABLE 2a
XPS fitting parameter for Ni2p3,
Mn2p3, Co2p3, Al2p, B1s, and W4f.

| | Sensitivity | Fitting range | Defined | |
|---|---|---|---|---|
| Element | factor | (eV) | peak(s) | Line shape |
| Ni | 14.61 | 851.1 ± 0.1- | Ni2p3, Ni2p3 | LA(1.33, |
| | | 869.4 ± 0.1 | satellite | 2.44, 69) |
| Mn | 9.17 | 639.9 ± 0.1- | Mn2p3, Mn2p3 | GL(30) |
| | | 649.5 ± 0.1 | satellite | |
| Co | 12.62 | 775.4 ± 0.1- | Co2p3-1, Co2p3-2, | GL(30) |
| | | 792.7 ± 0.3 | Co2p3 satellite | |
| Al | 0.54 | 78.5 ± 0.1- | Al2p peak, Ni3p1, | GL(30) |
| | | 64.1 ± 0.1 | Ni3p3, Ni3p1 | |
| | | | satellite, Ni3p3 | |
| | | | satellite | |
| B | 0.49 | 187.0 ± 0.1- | B1s peak | GL(30) |
| | | 196.3 ± 0.1 | | |
| W | 9.8 | 32.0 ± 0.1- | W4f7, W4f5, | GL(30) |
| | | 43.0 ± 0.1 | and W5p3 | |

For Al, Co, and W peaks, constraints are set for each defined peak according to Table 2b. Ni3p and W5p3 are not quantified.

TABLE 2b
XPS fitting constraints for Al2p peak fitting.

| | | Fitting range | FWHM | |
|---|---|---|---|---|
| Element | Defined peak | (eV) | (eV) | Area |
| Al | Ni3p3 | 66.0-68.0 | 0.5-2.9 | No constraint set |
| | Ni3p1 | 68.0-70 | Equal to | 50% of Ni3p3 area |
| | | | Ni3p3 | |
| | Ni3p3 satellite | 71.0-72.0 | 0.5-2.9 | 40% of Ni3p3 area |
| | Ni3p1 satellite | 73.0-75.0 | 0.5-2.9 | 20% of Ni3p3 area |
| | Al2p peak | 74.0-76.0 | 0.5-3.0 | No constraint set |
| Co | Co2p3-1 | 776.0-780.9 | 0.5-4.0 | No constraint set |
| | Co2p3-2 | 781.0-785.0 | 0.5-4.0 | No constraint set |
| | Co2p3 satellite | 785.1-792.0 | 0.5-4.0 | No constraint set |
| W | W4f7 | 33.0-36.0 | 0.2-4.0 | No constraint set |
| | W4f5 | 36.1-39.0 | Equal to | 75% of W4f7 area |
| | | | W4f7 | |
| | W5p3 | 39.1-43.0 | 0.5-2.5 | No constraint set |

The Al, B, and W surface contents as determined by XPS are expressed as molar fractions of Al, B, and W, respectively, in the surface layer of the particles divided by the total content of Ni, Mn, Co, Al, B, and W, in said surface layer. It is calculated as follows:

$${Al}_{B} = Al ( at \% ) / ( Ni ( at \% ) + Mn ( at \% ) + Co ( at \% ) + B ( at \% ) + Al ( at \% ) + W ( at \% ) ) * 100 \\ {B}_{B} = B ( at \% ) / ( Ni ( at \% ) + Mn ( at \% ) + Co ( at \% ) + B ( at \% ) + Al ( at \% ) + W ( at \% ) ) * 100 \\ {W}_{B} = W ( at \% ) / ( Ni ( at \% ) + Mn ( at \% ) + Co ( at \% ) + B ( at \% ) + Al ( at \% ) + W ( at \% ) ) * 100.$$

### 2. Examples and Comparative Examples

### Comparative Example 1

A poly-crystalline positive electrode active material labelled as CEX1 is prepared according to the following steps:

Step 1) Transition metal oxidized hydroxide precursor preparation: A nickel-based transition metal oxidized hydroxide powder (TMH1) having a metal composition of Ni_{0.63}Mn_{0.17}Co_{0.20} was prepared by a co-precipitation process in a large-scale continuous stirred tank reactor (CSTR) with mixed nickel manganese cobalt sulphates, sodium hydroxide, and ammonia.

Step 2) First mixing: the TMH1 prepared from Step 1) and LiOH as a lithium source were homogenously mixed with a lithium to metal (Ni, Mn and Co) ratio of 1.03 in an industrial blending equipment to obtain a first mixture.

Step 3) First heating: the first mixture from Step 2) was heated at 860° C. for 10 hours under an oxygen atmosphere. The heated product was crushed, classified, and sieved to obtain a first heated product.

Step 4) Second mixing: the second heated product from Step 3) was mixed with H₃BO₃ as B source to obtain a second mixture comprising 500 ppm B.

Step 5) Second heating: the second mixture from Step 4) was heated at 350° C. for 7 hours under an oxygen atmosphere to obtain CEX1 comprising Ni, Mn, and Co in a ratio Ni:Mn:Co of 0.636:0.162:0.197 as obtained by ICP-OES. CEX1 has a D50 of 10 μm.

### Example 1

A single-crystalline positive electrode active material labelled as EX1 is prepared according to the following steps:

Step 1) Transition metal oxidized hydroxide precursor preparation: A nickel-based transition metal oxidized hydroxide powder (TMH2) having a metal composition of Ni_{0.63}Mn_{0.22}Co_{0.15} was prepared by a co-precipitation process in a large-scale continuous stirred tank reactor (CSTR) with mixed nickel manganese cobalt sulphates, sodium hydroxide, and ammonia.

Step 2) First mixing: the TMH2 prepared from Step 1) was mixed with Li₂CO₃ in an industrial blender to obtain a first mixture having a lithium to metal (Ni, Mn, and Co) ratio of 0.85.

Step 3) First heating: The first mixture from Step 2) was heated at 900° C. for 10 hours in dry air atmosphere to obtain a first heated cake.

Step 4) Second mixing: the first heated cake from Step 3) was mixed with LiOH in an industrial blender to obtain a second mixture having a lithium to metal (Ni, Mn, and Co) ratio of 1.05.

Step 5) Second heating: the second mixture from Step 4) was heated at 950° C. for 10 hours in dry air, followed by wet milling, drying, and sieving process to obtain a second heated product.

Step 6) Third mixing: the second heated product from Step 5) was mixed with 2 mol % C0304 and 5 mol % of LiOH, each with respect to the total molar contents of Ni, Mn, and Co to obtain a third mixture.

Step 7) Third heating: the third mixture from Step 6) was heated at 775° C. for 12 hours in dry air to produce a third heated product.

Step 8) Fourth mixing: the third heated product from Step 7) was mixed with H₃BO₃ as B source to obtain a fourth mixture comprising 500 ppm of B.

Step 9) Fourth heating: the fourth mixture from Step 8) was heated at 350° C. for 7 hours under an oxygen atmosphere to obtain EX1 comprising Ni, Mn, and Co in a ratio Ni:Mn:Co of 0.61:0.22:0.17 as obtained by ICP-OES. EX1 has a D50 of 7 μm.

Due to the wet milling in step 5) EX1 is a single-crystalline powder.

### Comparative Example 2

A poly-crystalline positive electrode active material labelled as CEX2.1 is prepared according to the following steps:

Step 1) Transition metal oxidized hydroxide precursor preparation: A nickel-based transition metal oxidized hydroxide powder (TMH3) having a metal composition Ni_{0.83}Mn_{0.12}Co_{0.05} was prepared by a co-precipitation process in a large-scale continuous stirred tank reactor (CSTR) with mixed nickel manganese cobalt sulfates, sodium hydroxide, and ammonia.

Step 2) First mixing: the TMH3 prepared from Step 1) was mixed with LiOH in an industrial blender to obtain a first mixture having a lithium to metal (Ni, Mn, and Co) ratio of 0.975.

Step 3) First heating: The first mixture from Step 2) was heated at 765° C. for 10 hours in an oxidizing atmosphere to obtain a first heated product followed by milling and sieving.

Step 4) Second mixing: the first heated product from Step 3) and LiOH as a lithium source were homogenously mixed with a lithium to metal (Ni, Mn, and Co) ratio of 1.03 in an industrial blending equipment to obtain a second mixture.

Step 5) Second heating: the second mixture from Step 4) was heated at 770° C. for 12 hours under an oxygen atmosphere to obtain a second heated product.

Step 6) Third mixing: the second heated product from Step 5) was mixed with H₃BO₃ as B source to obtain a third mixture comprising 500 ppm of B.

Step 7) Third heating: the third mixture from Step 6) was heated at 350° C. for 7 hours under an oxygen atmosphere to obtain CEX2.1 comprising Ni, Mn, and Co in a ratio Ni:Mn:Co of 0.826:0.120:0.050 as obtained by ICP-OES. CEX2.1 has a D50 of 6 μm.

CEX2.2 is prepared according to the same method as CEX2.1 except that more H₃BO₃ powder was added in Step 6) to obtain a third mixture comprising 1000 ppm of B.

### Example 2

A single-crystalline positive electrode active material labelled as EX2.1 is prepared according to the following steps:

Step 1) Transition metal oxidized hydroxide precursor preparation: A nickel-based transition metal oxidized hydroxide powder (TMH4) having a metal composition Ni_{0.86}Mn_{0.07}Co_{0.07} was prepared by a co-precipitation process in a large-scale continuous stirred tank reactor (CSTR) with mixed nickel manganese cobalt sulfates, sodium hydroxide, and ammonia.

Step 2) Precursor oxidation: the TMH4 prepared from Step 1) was heated at 400° C. for 7 hours in an oxidizing atmosphere to obtain a heated product.

Step 3) First mixing: the heated product prepared from Step 2) was mixed with LiOH in an industrial blender to obtain a first mixture having a lithium to metal (Ni, Mn, and Co) ratio of 0.96.

Step 4) First heating: The first mixture from Step 3) was heated at 890° C. for 11 hours in an oxidizing atmosphere to obtain a first heated product.

Step 5) Wet bead milling: The first heated product from Step 4) was bead milled in a solution containing 0.5 mol % Co with respect to the total molar contents of Ni, Mn, and Co in the first heated product followed by drying and sieving process to obtain a milled product. The bead milling solid to solution weight ratio was 6:4 and was conducted for 20 minutes.

Step 6) Second mixing: the milled product obtained from Step 5) was mixed in an industrial blender with 1.5 mol % Co from Co₃O₄ and 7.5 mol % Li from LiOH, each with respect to the total molar contents of Ni, Mn, and Co in the milled product to obtain a second mixture.

Step 7) Second heating: The second mixture from Step 6) was heated at 760° C. for 10 hours in an oxidizing atmosphere followed by crushing and sieving with 250 ppm of alumina powder to obtain a second heated product.

Step 8) Third mixing: the second heated product from Step 7) was mixed with H₃BO₃ as B source to obtain a third mixture comprising 500 ppm of B.

Step 9) Third heating: the third mixture from Step 8) was heated at 350° C. for 7 hours under an oxygen atmosphere to obtain EX2.1 comprising Ni, Mn, and Co in a ratio Ni:Mn:Co of 0.84:0.07:0.09 as obtained by ICP-OES. EX2.1 has a D50 of 4 μm.

Due to the wet milling in step 5) EX2.1 is a single-crystalline powder.

EX2.2 is prepared according to the same method as EX2.1 except that more H₃BO₃ powder was added in Step 8) to obtain a third mixture comprising 900 ppm of B.

EX2.3 is prepared according to the same method as EX2.1 except that more alumina was added in Step 7) during sieving and more H₃BO₃ powder was added in Step 8) to obtain a third mixture comprising 500 ppm of Al and 1100 ppm of B.

EX2.4 is prepared according to the same method as EX2.1 except that more alumina was added in Step 7) during sieving and more H₃BO₃ powder was added in Step 8 to obtain a third mixture comprising 500 ppm of Al and 1300 ppm of B.

### Comparative Example 3

CEX3 is prepared according to the same method as EX2.1 except that more alumina was added in Step 7) during sieving and more H₃BO₃ powder was added in Step 8) to obtain a third mixture comprising 500 ppm of Al and 2000 ppm of B.

### Example 3

A single-crystalline positive electrode active material labelled as EX3 is prepared according to the following steps:

Step 1) Transition metal oxidized hydroxide precursor preparation: A nickel-based transition metal oxidized hydroxide powder (TMH5) having a metal composition Ni_{0.90}Mn_{0.05}Co_{0.05} was prepared by a co-precipitation process in a large-scale continuous stirred tank reactor (CSTR) with mixed nickel manganese cobalt sulfates, sodium hydroxide, and ammonia.

Step 2) First mixing: the TMH5 prepared from Step 1) was mixed with LiOH and ZrO₂ in an industrial blender to obtain a first mixture having a lithium to metal (Ni, Mn, and Co) ratio of 0.99 and 1000 ppm of Zr.

Step 3) First heating: The first mixture from Step 2) was heated at 890° C. for 11 hours in an oxidizing atmosphere to obtain a first heated product.

Step 4) Wet bead milling: The first heated product from Step 3) was bead milled in a solution containing 0.5 mol % Co with respect to the total molar contents of Ni, Mn, and Co in the first heated product followed by drying and sieving process to obtain a milled product. The bead milling solid to solution weight ratio is 6:4 and was conducted for 20 minutes.

Step 5) Second mixing: the milled product obtained from Step 4) was mixed in an industrial blender with 1.5 mol % Co from Co₃O₄ and 1000 ppm of Zr from ZrO₂ with respect to the total molar contents of Ni, Mn, and Co in the milled product to obtain a second mixture.

Step 6) Second heating: The second mixture from Step 5) was heated at 760° C. for 12 hours in an oxidizing atmosphere followed by crushing and sieving process together with alumina (Al₂O₃) powder. The sieved powder comprising 500 ppm of Al.

Step 7) Third mixing: the sieved product from Step 6) was mixed with H₃BO₃ as B source to obtain a third mixture comprising 1000 ppm of B.

Step 8) Third heating: the third mixture from Step 7) was heated at 350° C. for 7 hours under an oxygen atmosphere to obtain EX3 comprising Ni, Mn, and Co in a ratio Ni:Mn: Co of 0.87:0.05:0.07 as obtained by ICP-OES. EX3 has a D50 of 4 μm.

### Example 4

A single-crystalline positive electrode active material labelled as EX4 is prepared according to the following steps:

Step 1) Transition metal oxidized hydroxide precursor preparation: A nickel-based transition metal oxidized hydroxide powder (TMH6) having a metal composition Ni_{0.86}Mn_{0.07}Co_{0.07} was prepared by a co-precipitation process in a large-scale continuous stirred tank reactor (CSTR) with mixed nickel manganese cobalt sulfates, sodium hydroxide, and ammonia.

Step 2) Heating: the TMH6 prepared from Step 1) was heated at 400° C. for 7 hours in an oxidizing atmosphere to obtain a heated product.

Step 3) First mixing: the heated product prepared from Step 2) was mixed with LiOH in an industrial blender to obtain a first mixture having a lithium to metal (Ni, Mn, and Co) ratio of 0.96.

Step 4) First heating: The first mixture from Step 3) was heated at 890° C. for 11 hours in an oxidizing atmosphere to obtain a first heated product.

Step 5) Wet bead milling: The first heated product from Step 4) was bead milled in a solution containing 0.5 mol % Co with respect to the total molar contents of Ni, Mn, and Co in the first heated product followed by drying and sieving process to obtain a milled product.

The bead milling solid to solution weight ratio is 6:4 and is conducted for 20 minutes.

Step 6) Second mixing: the milled product obtained from Step 5) was mixed in an industrial blender with 3.0 mol % Co from Co₃O₄, 4000 ppm of Zr from ZrO₂, and 7.5 mol % Li from LiOH, each with respect to the total molar contents of Ni, Mn, and Co in the milled product to obtain a second mixture.

Step 7) Second heating: The second mixture from Step 6) was heated at 760° C. for 10 hours in an oxidizing atmosphere followed by crushing and sieving process together with alumina (Al₂O₃) powder. The sieved powder comprising 500 ppm of Al.

Step 8) Third mixing: the sieved product from Step 7) was mixed with H₃BO₃ as B source and WO₃ as W source to obtain a third mixture comprising 500 ppm of B and 4500 ppm of W.

Step 9) Third heating: the third mixture from Step 8) was heated at 350° C. for 7 hours under an oxygen atmosphere to obtain EX4 comprising Ni, Mn, and Co in a ratio Ni:Mn: Co of 0.82:0.07:0.10 as obtained by ICP-OES. EX2.1 has a D50 of 4 μm.

TABLE 3
Summary of the composition and the corresponding electrochemical
properties of examples and comparative examples

| | | ICP | | | | | | | |
|---|---|---|---|---|---|---|---|---|---|
| | | Ni | | | | | | | |
| | | (mol %, | | | | | | | |
| | | relative | Al_{A}* | B_{A}* | XPS** | | XPS**/ICP* | | DQ5 |
| ID | Morphology | to M′) | (mol %) | (mol %) | Al_{B} | B_{B} | Al_{B}/Al_{A} | B_{B}/B_{A} | (mAh/g) |
| CEX1 | Poly | 64 | 0.01 | 0.45 | 0.0 | 45.7 | 0 | 102 | 160.0 |
| EX1 | Single | 61 | 0.01 | 0.45 | 0.0 | 79.5 | 0 | 177 | 168.7 |
| CEX2.1 | Poly | 83 | 0.01 | 0.45 | 0.0 | 26.5 | 0 | 59 | 188.2 |
| CEX2.2 | Poly | 83 | 0.01 | 0.90 | 0.0 | 75.7 | 0 | 84 | 171.5 |
| EX2.1 | Single | 84 | 0.07 | 0.45 | 8.52 | 69.2 | 95 | 154 | 195.5 |
| EX2.2 | Single | 83 | 0.07 | 0.81 | 8.17 | 84.8 | 91 | 105 | 198.7 |
| EX2.3 | Single | 83 | 0.18 | 0.99 | 15.72 | 65.4 | 87 | 66 | 196.4 |
| EX2.4 | Single | 83 | 0.18 | 1.17 | 11.80 | 73.7 | 66 | 63 | 195.0 |
| CEX3 | Single | 83 | 0.18 | 1.80 | 6.49 | 88.8 | 36 | 49 | 163.5 |
| EX3 | Single | 87 | 0.18 | 0.90 | n.a | n.a | n.a | n.a | 204.7 |
| EX4 | Single | 82 | 0.18 | 0.45 | n.a | n.a | n.a | n.a | 195.5 |

*calculated versus the total molar fraction of Ni, Mn, Co, Al, B, and W, as analyzed by ICP-OES
**calculated versus the total molar fraction of Ni, Mn, Co, Al, B, and W, as analyzed by XPS
n.a: not available

Table 3 summarizes the composition of examples and comparative examples and their corresponding electrochemical properties. Both CEX1 having poly-crystalline morphology and EX1 having single-crystalline morphology are comprising Ni and B in the similar amount. Comparison between CEX1 and EX1 shows B addition is more beneficial to improve solid-state rechargeable battery performance for positive electrode active material having single-crystalline morphology.

Likewise, single-crystalline EX2.1 and EX2.2 with the same Ni content demonstrate higher DQ5 in the solid-state rechargeable battery test as compared to poly-crystalline CEX2.1 and CEX2.2. It is also observed that DQ5 of CEX2.2 decreases in comparison with CEX2.1. It shows further B addition to poly-crystalline material is not beneficial.

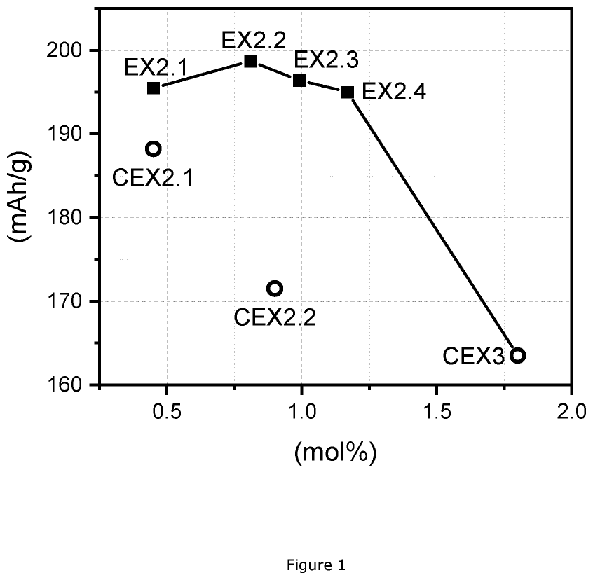

Single-crystalline EX2.3 and EX2.4 comprising Al and B altogether maintain the good DQ1 performance of higher than CEX2.1. It is shown that subsequent Al and B presence is also advantageous to improve the electrochemical properties of positive electrode active material in solid-state rechargeable battery. On the other hand, CEX3 which comprises 0.18 mol % Al and 1.8 mol % B is not suitable to be applied in solid-state rechargeable battery. The relationship of DQ5 and amount of B for positive electrode active material having Ni content around 83% is depicted in FIG. 1.

EX4 further comprises 0.18 mol % W and has an improved DQ5 in comparison with CEX2.1 having the similar Ni and B content.

Table 3 also summarizes the XPS analysis result of EX2 showing Al and B fraction with respect to the total atomic fraction of Ni, Mn, and Co. The table also compares the result with that of ICP. The atomic ratio higher than 1 indicating said Al, B, and W are enriched in the surface of the positive electrode active material as associated with the XPS measurement which signal is acquired from the first few nanometers (e.g. 1 nm to 10 nm) of the uppermost part of a sample, i.e. surface layer. On the other hand, Al, B, and W atomic ratio from ICP measurement is obtained from the entire particles. Therefore, the ratio of XPS to ICP of higher than 1 indicates the presence of elements Al, B, or W mostly on the surface of the positive electrode active material.

1-24. (canceled)

25. A positive electrode active material configured for use in a solid-state rechargeable battery, wherein the positive electrode active material comprises Li, M′, and oxygen, wherein M′ comprises:
Ni in a content x, wherein 50.0≤x≤95.0 mol %, relative to M′,
Co in a content y, wherein 0≤y≤40.0 mol %, relative to M′,
Mn in a content z, wherein 0≤z≤70.0 mol %, relative to M′,
an element other than Li, O, Ni, Co, Mn, Al, B, and W in a content a, wherein 0≤a≤2.0 mol %, relative to M′, and,
B in a content b, wherein 0.01≤b≤1.6 mol %, relative to M′,
Al in a content c, wherein 0.00≤c≤1.5 mol %, relative to M′,
W in a content d, wherein 0.00≤d≤1.5 mol %, relative to M′,
wherein x, y, z, a, b, c, and d are measured by ICP-OES,
wherein x+y+z+a+b+c+d is 100.0 mol %,
wherein the positive electrode active material has a B content B_{A} defined as
$$\frac{b}{( x + y + z + b + c + d )} ,$$
wherein the positive electrode active material has a B content B_{B} wherein B_{B} is determined by XPS analysis, wherein B_{B} is expressed as molar fraction compared to the sum of molar fractions of Ni, Mn, Co, B, Al, and W, as measured by XPS analysis,
wherein the ratio B_{B}/B_{A}>10.0, and
wherein the material is a single-crystalline powder.

26. The positive electrode active material according to claim 25, wherein 50.0≤x≤70.0.

27. The positive electrode active material according to claim 25, wherein 70.0≤x≤95.0.

28. The positive electrode active material according to claim 25, wherein the ratio B_{B}/B_{A}>30.0.

29. The positive electrode active material according to claim 25, wherein the B content b is ≥0.05 mol %, relative to M′, as measured by ICP-OES.

30. The positive electrode active material according to claim 25, wherein the Al content is 0.01 mol %≤c≤1.5 mol %, relative to M′ as measured by ICP-OES.

31. The positive electrode active material according to claim 25, wherein the positive electrode active material has an Al content Al_{A} defined as
$$\frac{c}{( x + y + z + b + c + d )} ,$$
wherein the positive electrode active material has an Al content Al_{B} determined by XPS analysis, wherein Al_{B} is expressed as molar fraction compared to the sum of molar fractions of Co, Mn, Ni, B, Al, and W, as measured by XPS analysis, wherein the ratio Al_{B}/Al_{A}>10.0.

32. The positive electrode active material according to claim 25, wherein the ratio Al_{B}/Al_{A}≥30.

33. The positive electrode active material according to claim 25, wherein the ratio B_{B}/B_{A}<300.

34. The positive electrode active material according to claim 25, wherein the ratio Al_{B}/Al_{A}<300.

35. The positive electrode active material according to claim 25, wherein the W content is 0.01 mol %≤d≤2.0 mol %, relative to M′, as measured by ICP-OES.

36. The positive electrode active material according to claim 25, wherein the positive electrode active material has a W content W_{A} defined as
$$\frac{d}{( x + y + z + b + c + d )} ,$$
wherein the positive electrode active material has a W content W_{B} determined by XPS analysis, wherein W_{B} is expressed as molar fraction compared to the sum of molar fractions of Co, Mn, Ni, B, Al, and W, as measured by XPS analysis, wherein the ratio W_{B}/W_{A}>10.0.

37. The positive electrode active material according to claim 25, wherein the ratio W_{B}/W_{A}>20.

38. The positive electrode active material according to claim 25, wherein the ratio W_{B}/W_{A}<300.

39. The positive electrode active material according to claim 25, wherein the positive electrode active material has a median particle size D50 of between 2.0 m and 10.0 m, as determined by laser diffraction particle size analysis.

40. The positive electrode active material according to claim 25, wherein the solid-state rechargeable battery is a sulfide based solid-state battery.

41. The positive electrode active material according to claim 25, wherein the solid-state battery comprises a solid electrolyte, and wherein the solid electrolyte is a sulfur containing compound.

42. A catholyte for a solid-state rechargeable battery comprising a positive electrode active material and a solid electrolyte, and wherein the positive electrode active material comprises Li, M′, and oxygen, wherein M′ comprises:
Ni in a content x, wherein 50≤y≤95.0 mol %, relative to M′,
Co in a content y, wherein 0≤y≤40.0 mol %, relative to M′,
Mn in a content z, wherein 0≤z≤70.0 mol %, relative to M′,
an element other than Li, O, Ni, Co, Mn, Al, B, and W in a content a, wherein 0≤a≤2.0 mol %, relative to M′, and,
B in a content b, wherein 0.01≤b≤1.6 mol %, relative to M′,
Al in a content c, wherein 0.00≤c≤1.5 mol %, relative to M′,
W in a content d, wherein 0.00≤d≤1.5 mol %, relative to M′,
wherein x, y, z, a, b, c, and d are measured by ICP-OES,
wherein x+y+z+a+b+c+d is 100.0 mol %,
wherein the positive electrode active material has a B content B_{A} defined as
$$\frac{b}{( x + y + z + b + c + d )} ,$$
wherein the positive electrode active material has a B content B_{B} wherein B_{B} is determined by XPS analysis, wherein B_{B} is expressed as molar fraction compared to the sum of molar fractions of Ni, Mn, Co, B, Al, and W, as measured by XPS analysis,
wherein the ratio B_{B}/B_{A}>10.0, and
wherein the material is a single-crystalline powder.

43. The catholyte according to claim 42, wherein the solid electrolyte is a sulfide based electrolyte.

44. A positive electrode for a solid-state rechargeable battery comprising a catholyte according to claim 42.

45. A solid-state rechargeable battery comprising the positive electrode according to claim 44.

46. A solid-state rechargeable battery comprising the positive electrode active material as described in claim 42.

47. A solid-state rechargeable battery according to claim 46 comprising a sulfide-based electrolyte.
